(19) United States
(12) Patent Application Publication
(10) Pub. No.: US 2009/0056074 A1
(43) Pub. Date: Mar. 5, 2009

(54) AUTOMOBILE DOOR HINGE

(76) Inventor: Daniel A. Chase, Kingsville, MD (US)

Correspondence Address: JEFFREY C. LEW, 2205 SILVERSIDE ROAD, WILMINGTON, DE, 19810, US

(21) Appl. No.: 11/846,163

(22) Filed: Aug. 28, 2007

(51) Int. Cl. E05D 11/10

(52) U.S. Cl. 16/321

(57) ABSTRACT

A novel single axis automobile door hinge allows the door to open and close through an arc oriented at an oblique angle to the horizontal and vertical. A single hinge is utilized for each door. The hinge fits within existing vacant space forward of the door and between the chassis and fender such that little if any removal of original equipment manufactured body or parts is called for during installation, other than usually simple unbolting of the manufacturer-supplied traditional vertical axis door hinges. Often the novel hinge can be installed by bolting directly to the existing door hinge bolt holes.

### FIELD OF THE INVENTION

This invention relates to automobile doors that open and close at an oblique angle to horizontal and vertical. More specifically, it relates to a single hinge single axis system positioned in the vacant space between an automobile fender and chassis wall which changes horizontal swing-out doors to open at an oblique angle.

### BACKGROUND OF THE INVENTION

An overwhelming majority of automobiles throughout the world are manufactured and assembled such that the doors swing out horizontally about a vertical axis of rotation. The standard mechanism utilizes a pair of single axis hinges for each door. Typically each hinge is bolted to a vertical member of the vehicle's door-jamb and to an adjacent vertically oriented part of the door. One hinge is positioned high on the door and the other at a distance below. The hinge pins are coaxially aligned in a vertical orientation Most commonly automobile doors are hinged at the forward edge such that when the door is opened, the rear edge swings outward in a horizontal arc away from the body of the automobile.

Just about every aspect, including door opening technology, has been modified since inception of the automobile. Various practical reasons have been suggested for wanting to change the horizontal swing-out style of door opening. For example, it is said that horizontally swinging doors provide little room for stepping in and out when the automobile is in a narrow parking space or crowded parking lot. Also, horizontally swinging doors have potential for doing damage to themselves and to adjacent vehicles, especially when the automobile is parked sideways on slanting terrain that can cause the door to open unexpectedly fast upon releasing the latch. It cannot be denied that there also is great interest in changing the customary horizontally swinging door to achieve a pleasing aesthetic appearance and to exhibit an individualized and distinctive style. Thus for many reasons there is a large demand among diverse automobile enthusiasts to have automobiles with doors that open in a non-traditionally appearing way.

The automobile owner seeking to have a, vehicle with non-traditionally opening doors will have difficulty finding or having a new vehicle built with this feature. Enthusiasts thus look to converting existing automobiles with original equipment manufactured (i.e., “OEM”) horizontally swinging doors to non-traditional opening doors. Hence it is very desirable to have a system suitable for retrofitting existing cars with non-standard door movement characteristics.

It should be possible to have an existing automobile customized with non-horizontally swinging doors on an individual, one-of-a-kind basis. Many customization and body shops perform such services. However, the frequent need to cut into the chassis structure of the vehicle to make room for the modified hinges and related parts requires much skilled labor. For this and other reasons individualized customization can make retrofitting nontraditional opening doors, to an existing automobile time consuming and expensive. It is much desired to have a retrofitting system for nontraditional door opening that is relatively simple, easy, quick and less expensive to execute.

Not surprisingly various attempts have been made to provide non-traditionally opening automobile doors. For example, sliding, gull wing and vertical lift doors have been tried. Sliding doors can be found on vans and passenger minivans but are not known to be utilized in smaller bodied passenger cars. Gull wing and vertical lift doors generally use single axis hinges connecting the door frame to a horizontal edge oriented fore-to-aft on the door jamb. Gull wing doors are preeminently exemplified by the DeLorean Motor Company design in which the hinge is positioned in the roof such that the door lifts like a clam shell above the automobile. The vertical lift style follows in the style of the Lamborghini sports car and is occasionally referred to as a “lambo door”. These doors hinge about a single horizontal axis oriented from side-to-side of the vehicle at a high and forward position of the door. Consequently, the rear of the door rotates upward and forward in a vertical plane. The door and fender shapes are matched so that the door does not contact the car body when opening.

U.S. Pat. No. 7,210,200 discloses a multi-axis door hinge that permits an automobile door to pivot in a combination of horizontal swing out and vertical lift styles. That is, the door swings out first in a horizontal plane on a vertically oriented hinge axis then vertically on a horizontally oriented hinge axis. This allows an existing stock door that would ordinarily contact the fender if simply rotated in the vertical lift manner to achieve a vertical lift effect. That is, the door moves horizontally outward where it will clear the fender before rotating upward.

The above described systems are based on single axis hinges and that each cause the door to open in a circular arc. The axes of rotation of the arcs are aligned substantially with the horizontal or vertical. It is desirable to have a nontraditionally opening door that opens at an oblique angle. Such a door will have a larger entrance area for ease of entry and exit while not interfering with close adjacent vehicles as much as the vertical or horizontal single axis hinged doors. Furthermore, obliquely opening doors have a strikingly distinctive appearance giving them much desired aesthetic appeal.

A single axis hinge system that permits an automobile door to swing about an oblique angle of rotation is commercially available under the name GT Factory Gull Wing door hinge. It uses a robust hinge of about six inches in length that mounts within and replaces a portion of the windshield pillar. The windshield pillar is a member of the chassis that extends on both sides of the windshield from the lower corner upward and typically rearward to the roof. Installation of this hinge routinely necessitates cutting out a niche from the windshield pillar to be occupied by the hinge. Such cutting requires skill, tools and time to implement which can make the installation costly. Additionally, the windshield pillar can be an important component of the crash protection system designed to maintain a safe cocoon for the vehicle occupants in the event of collision. Any cutting into and reconstruction of the pillar can weaken the structure unless performed carefully to avoid weakening. It is desired to have a single axis hinge system that allows the door to open at an oblique angle without the need to remove a substantial amount of vehicle structure to accommodate the system.

### SUMMARY OF THE INVENTION

There is now disclosed a novel single axis automobile door hinge that allows the door to open and close through an arc oriented at an oblique angle to the horizontal and vertical. A single hinge is utilized for each door. The hinge fits within existing vacant space forward of the door and between the chassis and feeder such that little if any removal of OEM body or parts is called for during installation-, other than usually simple unbolting of the manufacturer-supplied traditional vertical axis door hinges. Often the novel hinge can be installed by bolting directly to the existing door hinge bolt holes.

Accordingly, the present invention provides a system for moving a door of an automobile through an arc about a single axis comprising at most one hinge element comprising (i) two tabs extending substantially radially outward from the axis, the second tab being pivotable about the axis relative to the first tab, (ii) a chassis base affixed to the first tab, (iii) an elongated arm affixed at a first end to the second tab, and (iv) a door base affixed to the end of the elongated and opposite the first end, in which the axis is oriented at a substantially oblique angle to horizontal and vertical directions, and in which the second tab, arm and door base define a U-shaped channel.

This invention also provides a method of retrofitting a door of an automobile to open obliquely comprising the steps of (A) providing an automobile having a chassis, a fender and an originally manufactured door with a vertical axis hinge that opens the door only in a horizontal arc, (B) removing the vertical axis hinge from the automobile and from the door, (C) providing a hinge system comprising at most one hinge element comprising (i) two tabs extending substantially radially outward from the axis, the second tab being pivotable about the axis relative to the first tab, (ii) a chassis base affixed to the first tab, (iii) an elongated arm affixed at a first end to the second tab, and (iv) a door base affixed to the end of the elongated aim opposite the first end, in which the axis is oriented at a substantially oblique angle to horizontal and vertical directions, and in which the second tab, arm and door base define a U-shaped channel, (D) affixing the door base to a forward facing wall of the door, (E) positioning the hinge system between an outward facing wall of the chassis and an interior wall of the fender opposite said outward facing wall, and (F) affixing the chassis base to the outward facing wall.

### BRIEF DESCRIPTION OF THE DRAWINGS

FIG. 1 is a perspective view of an embodiment of a single axis, oblique angle opening automobile door hinge according to this invention.

FIG. 2 is a horizontal section view of the forward end of an automobile door joined to a vehicle chassis with the hinge of FIG. 1 in a door closed condition.

FIG. 3 is a horizontal section view of the forward end of an automobile door joined to a vehicle chassis with the hinge of FIG. 1 in a door open condition.

FIG. 4 is a perspective view of an embodiment of the novel hinge system including a chassis mounting plate according to the present invention.

FIG. 5 is a perspective view of an embodiment of a mounting alignment component suitable for use in combination with the door hinge of FIG. 1 accord to this invention.

FIG. 6 is a side elevation view of a chassis mounting plate in accord with an embodiment of this invention.

FIG. 7 is an exploded perspective view of an embodiment of an automobile door hinge according to this system.

### DETAILED DESCRIPTION OF THE INVENTION

The novel hinge system advantageously enables the door of an automobile to open at an oblique angle to the horizontal and vertical directions. The door is affixed to one pivoting side of a single hinge. The other pivoting side of the hinge is anchored to the vehicle chassis. Thus the door pivots about the axis of rotation of a single hinge, and importantly, the single hinge utilizes only a single axis of rotation.

The axis of the hinge rotation is oriented at an oblique angle. By “oblique angle” is meant that the axis of the hinge is substantially not aligned with the horizontal directions, i.e., front-rear and side-to-side directions, or the vertical direction. Preferably the door moves through a circular arc within a plane skewed with respect to the vertical and horizontal as defined by the axis of rotation of the hinge. Preferably the axis of the hinge is oriented from high, inboard and rearward to low, outboard and forward. Hence when opening, the door swings upward, outward and forward and when closing, it swings downward, inward and rearward. Moreover, the upward-outward-forward and downward-inward-rearward swings are each achieved in one smooth, continuous motion.

The oblique angle of rotation will depend to great degree upon the shape of the automobile. Preferably the angle will be within the range of about 10-70 degrees of each of the vertical, fore-to-aft, and side-to-side directions. Although automobile body styles include significant amount of curvature, it is recognized that the windshield and the doors each approximately define planar structures. For a particularly desirable aesthetic effect, the angle of rotation can be selected such the doors swing to a fully open condition in which the planes of the doors are aligned with the plane of the windshield. Then viewed from ahead looking rearward there appears a broad expanse of the hood and windshield flanked by the doors on opposite sides directed upward and outward. This aesthetic effect is achieved when the the axis of rotation of the novel hinge is approximately parallel with the angle of the windshield pillar.

Another important feature of the novel hinge system is that the whole assembly of the hinge and related parts fits within the volume of space forward of the door and between the inside of the fender and the outward facing wall of the chassis after the original equipment manufactured (i.e., “OEM”) vertical axis hinges are removed. It has been discovered that usually there is adequate room to mount the novel hinge system without the need to sculpt additional volume out of the stock body parts. Thus, installation avoids significant demolition of the stock body and can be effected by a simplified process.

The novel hinge system can be provided in a vehicle specific kit or a universal kit. By “by vehicle specific” is meant that the kit is designed to mate with the mounting surfaces on the outward facing wall of the chassis and the forward wall of the door being hinged for an individual vehicle model or a selected group of vehicle models that have a common structure. The vehicle specific kit will fit the vehicles of the selected model or group without substantially modifying either the parts of the kit or the vehicle. By “universal” is meant that the kit will fit substantially all vehicle models within broadly defined brands, classes and sizes of vehicles, such as sedans, sports cars, sport utility vehicles, pickup trucks, vans and minivans, to name a few. However, the universal kit usually will need some shape modification primarily of mounting plates that join the hinge and other core elements to the chassis of the vehicle. The term “chassis” refers to the primary structural skeleton of the vehicle, also known in the industry as a frame. The terms “chassis” and “frame” as applied to the vehicle body are meant to be interchangeable.

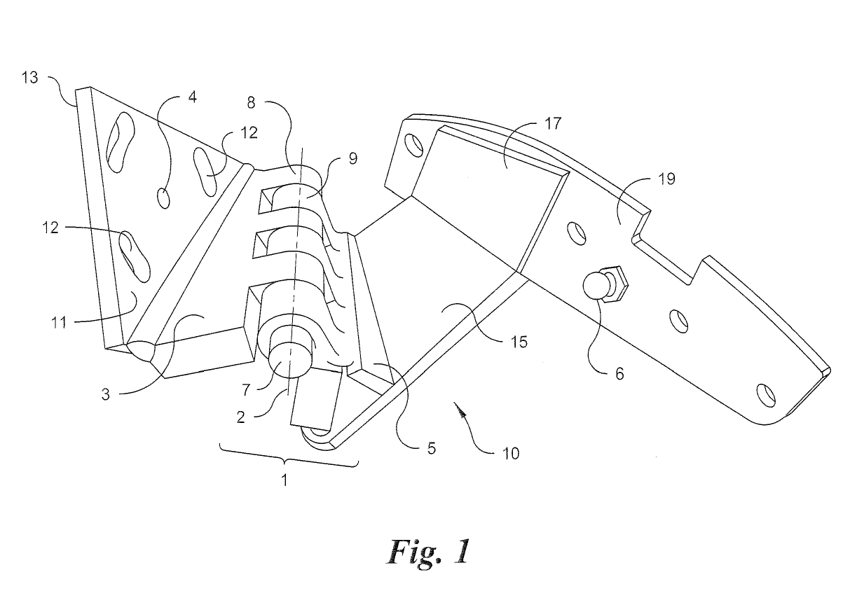

Structure of the novel hinge 10 according to a basic embodiment of the invention can be understood with reference to FIG. 1. The hinge has a single axis hinge element I constituted by three component parts, namely tabs 3 and 5 and hinge pin 7. Knuckles 8 extend from tab 3 and mesh with knuckles 9 extending from tab 5 to embrace pin 7 such that the tabs can pivot around the axis of rotation 2 coincident with the axis of the hinge pin. At a distance away from the hinge pin 7, tab 3 forms a chassis base 11. The chassis base rigidly and strongly connects the hinge system to the chassis. From second tab 5 the hinge forms an arm 15, and door base 17. An optional door mounting plate 19 secures the hinge to the forward facing wall of the door. The door mounting plate can be a separate element that is fastened to the hinge by attachment at the door base 17. The separate door mounting plate can be attached to the hinge by removable fasteners such as bolts or studs or by permanent fastening such as by welding. In other contemplated embodiments the door base 17 and the door mounting plate 19 can be merged into a single structural element such that the door base 17 alone secures the hinge to the forward facing wall of the door.

In addition to merely securing the door base to the door, the door mounting plate reinforces the strength of the forward facing wall of the door. Reinforcement is achieved by having the door mounting plate cover and bond to a larger area of the forward facing wall than does the door base. Preferably the door mounting plate covers at least 50% of the area of the forward facing wall of the door. More preferably, the door mounting plate area covers areas of the forward facing wall that overly both of the typically two OEM vertical axis hinge positions. In that event, the door mounting plate can be utilized to affix the second tab of the novel hinge to the door via both former OEM door hinge bolt holes with standard fasteners.

The hinge 10 can be attached to the vehicle by fastening the chassis base 11 directly to the chassis wall. The chassis base cant be affixed to the chassis by using removable fasteners or by using permanent fastening means, for example, by welds or rivets. Representative examples of removable fasteners that can be used are bolts and threaded studs with nuts. FIG. 1 shows that the chassis base 11 defines an array of plural holes 12 that can be used in connection with bolts or studs to fasten the chassis base to an adjacent structural element.

In a preferred embodiment the novel hinge system includes a mounting alignment component which permits the position of the hinge 10 to be adjusted and set such that in the door closed condition the door aligns accurately with the door jamb to provide aesthetically pleasing fit and finish clearance between the door and jamb equivalent to OEM quality. Typical attributes of high quality fit and finish include that the clearances between the door side and bottom edges and the jamb are uniform and small, that the upper edges of the door which can be a window free or window edge fully seats against weather stripping material on the jamb to seal against water intrusion and noise from air flow, and that the door lock closes and releases positively and easily from the latch of the door jamb.

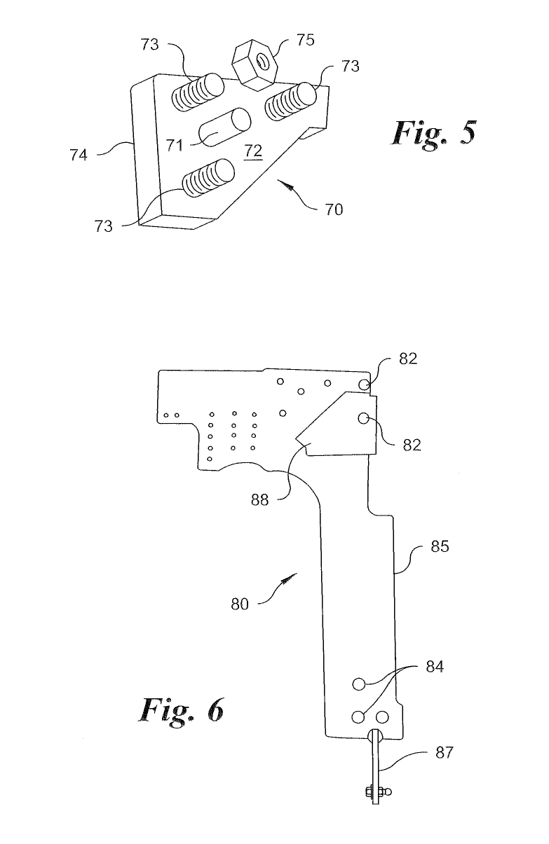

FIG. 5 shows an embodiment of a mounting alignment component 70 suitable for use in combination with the hinge 10 of FIG. 1. During installation of the novel hinge system, the rear side 74 of the mounting alignment component is affixed to the chassis. Face 72 of mounting alignment component 70 has an area approximately congruent with the back side 13 of the chassis base 11 (FIG. 1). As installed, back side 13 will be in adjacent contact with face 72. Therefore surface contours of face 72 and back side 13 should be complementary such that position of the chassis base 11 can be slidably adjusted relative to the mounting alignment component. Preferably both surface contours are planar. The illustrated embodiment of the mounting alignment component includes a plurality of studs 73 protruding outward front face 72, which are positioned to insert within corresponding holes 12 of the chassis base 11. Importantly, all of the holes 12 except one hole 4 are oversized relative to the outer diameter of the corresponding studs 73. The inner diameter of hole 4 is selected to match the outer diameter of corresponding stud 71 such that the chassis base 11 can rotate about the longitudinal axis of stud 71 when back side 13 is mated in adjacent contact with face 72. It should thus be understood that with the hinge 10 secured to the vehicle door, chassis base 11 is placed adjacent to the mounting alignment component 70 supported by stud 71 protruding through hole 4. With nuts 75 loosely threaded onto studs 73, the door is placed in its closed position within the door jamb. Chassis base 11 can rotate about stud 71 due to play provided by studs 73 in oversized holes 12. When the door within the jamb and door lock within its latch are aligned satisfactorily close to OEM quality conditions, nuts 75 are tightened to fix chassis base 11 and thus maintain hinge 10 in position relative to the chassis.

Other mechanical techniques for adjusting and locking the position of chassis base 11 relative to the mounting alignment component are contemplated. For example, the mounting alignment component can have female threaded bores instead of studs 71 and 73 such that correspondingly male threaded bolts can be inserted through correctly sized hole 4 and oversized holes 12 to secure the chassis base. In that case, chassis base could rotate about the axis of the bolt loosely threaded into hole 4 until proper alignment of parts is attained and all bolts are tightened.

In one aspect, the mounting alignment component (or the chassis base if no mounting alignment component is used,) is affixed directly to the outward facing wall of the chassis. Occasionally it is possible to secure the mounting alignment component or chassis base using the OEM hinge bolts and/or studs. The areas of the mounting alignment component and the chassis base are typically small. Alternatively, it is thus usually possible to find a flat or nearly flat expanse of the chassis wall to which the mounting alignment component or the chassis base directly, as the case may be, can be affixed with adequate stability for a door mount. The mounting alignment component or chassis base can be welded to the chassis wall. In some vehicles the chassis wall has insufficient structural integrity where the mounting alignment component or the chassis base are to be affixed. In such cases, the mounting alignment component or chassis base can be affixed with a conventional riveting technique. That is, appropriately positioned holes are drill through the parts and chassis wall, one or more backup plates are inserted from behind to bolster the chassis wall and rivets extending through the backup plates are deployed to achieve attachment.

In another aspect the novel hinge system can include a chassis mounting plate 80 (FIG. 6) as an additional element. The chassis mounting plate is a structural member that is deployed between the outward facing wall of the chassis and the m-mounting alignment component 70 if used, or the chassis base 11. That is, one side of chassis mounting plate contacts the chassis wall with the chassis base contacting the other side of the chassis mounting plate. If present, a mounting alignment component is sandwiched between the chassis mounting plate and the chassis base.

A primary purpose of the chassis mounting plate is to reinforce the chassis wall in the area where the hinge is attached. This makes the hinge system strong enough to support the weight of the normally heavy door which is extended high and far away from the vehicle body when fully open. It also helps to assure that the chassis wall does not deform even slightly with age and usage so that the door continues in extended service to latch properly and display high quality fit and finish with the door jamb when in the closed position.

The chassis mounting plate has a substantially sheet-like structure in that it has a large area and a thickness dimension much less than its characteristic length and width dimensions. The chassis mounting plate strengthens the chassis wall by overlying and attaching to a large area of the wall near the door jamb. The area covered by the chassis mounting plate is large in comparison to the areas that the chassis base and the mounting alignment component project on the chassis wall. The latter parts each preferably present areas of about 10 square inches to about 40 square inches. The chassis mounting plate preferably covers an area of the chassis wall of at least about 40 square inches, and also preferably has an area at least about 2 times the area, of the chassis base, and more preferably at least about 4 times the area of the chassis base. Typically the width of the chassis mounting plate along the long dimension is at least about 3 inches, preferably at least about 4 inches, more preferably at least about 6 inches. While not critical that the chassis mounting plate be of unit form thickness, the thickness dimension should be substantially uniform. Preferably the thickness dimension of at least 50% of the area of chassis mounting plate should be at least about ¼ inch, and more preferably at least ⅜ inch. Similar thickness characteristics apply to the door mounting plate as well. In addition to the foregoing considerations dimensions of the components of the novel hinge system depend on such variables as the automobile door size and weight and the shape of the chassis wall. Dimensions, materials of construction and shape of the binge system components are also selected to provide for adequate strength, stability and durability in view that they manipulate and support tie door which is a heavy object typically weighing at least about 100 lbs.

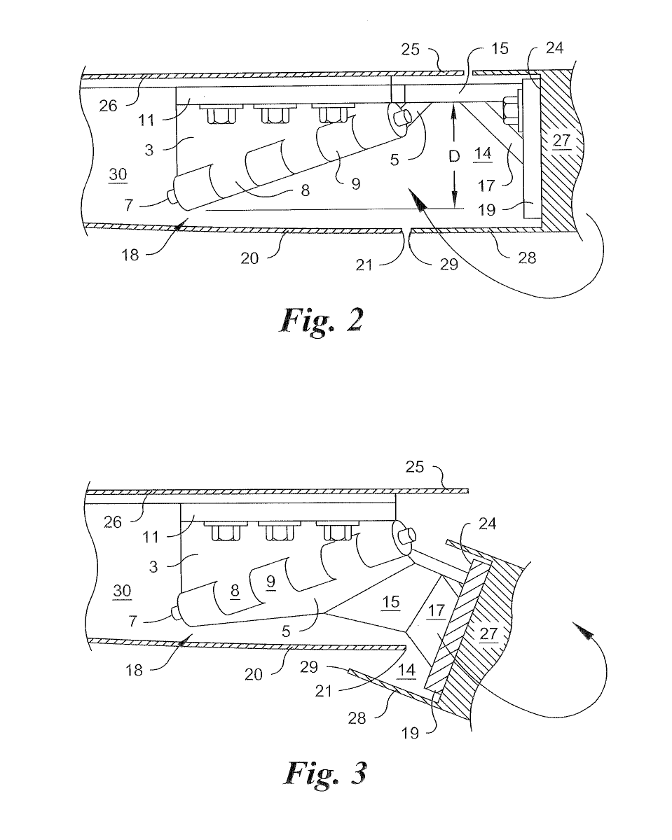

FIG. 6 illustrates that the chassis mounting plate 80 optionally includes a pocket 88. The pocket is a depression in the otherwise substantially uniform thickness chassis mounting plate. That is the the outward facing surface of the pocket does not rise as high from the rear surface of plate 80 as other areas of the plate. The depression of the pocket 88 receives at least a portion of the thickness of the hinge arm 15 (FIG. 1) when the hinge is in the door closed condition. This feature enables the arm to remain thick for structural integrity of the hinge without forcing the hinge arm to ride high on the surface of plate 80. This in turn locates the hinge pin and finger elements closer to the chassis wall to provide the gap 18 (FIGS. 2 and 3) which allows the hinge to open wide and swing the door very high.

To further advantage it is usually possible for the chassis mounting plate to extend coverage over the regions of the chassis wall where the OEM hinge hardware was formerly mounted. Holes 82 through the plate are positioned to correspond with the OEM bolt holes or studs as the case may be. Consequently and conveniently the chassis mounting plate can be at least partially affixed to the chassis wall using standard bolts or nuts at the OEM door mounts where the chassis is intrinsically robust by design. Additionally, the chassis mounting plate 80 can have a downward extending leg portion 85. This increases the chassis wall area being reinforced to further spread out the stress borne by the chassis to support the opening and closing door. It also preferably extends low enough to cover the location of the lower OEM door hinge mounts. Thus holes 84 can be positioned to correspond with the second set of OEM door hinge bolt holes or studs such that the chassis mounting plate provides two structurally sound points of attachment to the vehicle for the novel hinge system.

Because it covers a large area the chassis mounting plate also provides more freedom to place the chassis base of the hinge along the chassis wall than might otherwise be available. The hinge 10 can be mounted at any position of the chassis mounting plate that will optimize the effect of the upward and outward motion of the doors. Yet another function of the chassis mounting plate 80 is to provide a structural member 87 to which a lifting strut element of the novel hinge system can be connected The lifting strut aspect of this invention is described in greater detail below.

The chassis mounting plate has two sides. The side facing the chassis wall preferably has a surface contour shaped complementary to the contour of the outward facing chassis wall so as to provide a stable and strong Joint with the chassis. By following the contour of the chassis wall, the chassis mounting plate directly contacts a large area and effectively distributes the stress of supporting the door over a broad area of the chassis. The meeting surfaces of the chassis mounting plate and the chassis wall can be planar (i.e., flat) curved or a combination of flat and curved. If the chassis wall has mainly smoothe contours but also has surface features such as bolt heads protruding outward, then correspondingly positioned and larger indentations or cut-outs can be bored, cut away or otherwise machined into chassis mounting plate. Thus when the mounting plate is placed adjacent to the chassis wall, the protrusions can insert into the indentations thereby letting the mounting plate lie flush against the chassis wall (i.e., allowing areas of the chassis wall near the protrusions to contact corresponding areas of the the surface of the mounting plate).

The chassis mounting plate can be affixed to the chassis by any conventional fastening technique capable of delivering sufficient rigidity and strength for this utility. For example the mounting plate can be welded to the chassis. A contemplated supplemental or alternate attachment technique calls for drilling and tapping holes in the chassis and using correspondingly sized lag bolts to hold the plate in place. Typically however the chassis member underlying the mounting plate is too thin to accept tapping adequate to firmly retain the mounting plate. As mentioned, great preference is given to boring the chassis mounting plate in positions overlying holes of the OEM, vertical axis hinges that have been removed. Then bolts fitting the original bolt holes can be inserted and tightened to fix the mounting plate to the chassis. The mounting plate can be fixed to the chassis by a combination of bolts, lug nuts, rivets and welds as needed to provide a stable and strong anchor for the chassis base of the hinge.

The novel hinge system optionally further includes a lifting strut element. This is an elongated, length varying compression member, preferably a gas spring device well known in the art. One end of the lifting strut is mounted on the doorjamb, and preferably on the chassis mounting plate. More preferably the end of the lifting strut mounts to a section of the chassis mounting plate extending vertically below and distant from the axis of the door hinge. The other end is attached to the forward facing wall of the door. As the door opens, the lifting strut expands in length and exerts force against the door to approximately counter the weight of the door, thus making door opening easier. On closing the door, the lifting strut contracts in length and exerts force against the door thereby preventing the door from slamming hard against the jamb and latch. These and other details about the lifting strut will be disclosed in greater detail below.

Important aspects about the shape, function and inter-relationship of elements such as the tab 5, the arm 15, door base 17, and the door mounting plate 19 can be understood with reference to FIGS. 2 and 3 illustrating a partial horizontal cross section view of a portion of a vehicle in which the novel binge system of FIG. 1 is deployed. In particular, these figures depict the forward, driver's side door hinge. In FIG. 2, the door is closed and the lock, not shown, is latched. In FIG. 3, the door is open. For general orientation it should be understood that the vehicle is facing left with the driver's side door 27 positioned at the right portion of the drawing. The outside on the vehicle's driver side is below each figure and the hood/engine compartment (not shown) is forward and above each figure. Like parts have like reference numbers in the drawings. Curved arrows indicate direction in which the door can pivot around the hinge axis from the depicted position.

The figures show that the cross section profile of the unit constituted by tab 5, arm 15 and door base 17 has a U-shape which forms a channel 14. Chassis base 11 is affixed in contact with the outward facing wall 26 to the chassis 25. Door base 17 is affixed by door mounting plate 19 in contact with the forward facing wall 24 to the door 27. The forward portion of the outside surface of the door is represented by reference number 28. With the door nearly fully open (FIG. 3), arm 15 approaches fender 20 forward of the door. Preferably to prevent damage to structure and appearance of the fender, arm 15 should not contact the rearward edge 21 of fender 20. Thus it is seen that the U-shape cross section of channel 14 permits the door to swing open wider and higher without interference of fender 20 with aim 15 then would be possible without the channel being present to accept the edge of the fender.

Preferably the gap 18 between the inside surface of fender 20 and the peak of hinge knuckles 8 and 9 is small. The little clearance is due to the skew of the angle of the hinge pivot axis relative to the planes of the chassis and fender walls. The greater the skew angle, the wider and higher the door can open. It is seen that for a given distance between fender and chassis walls, the shorter the length of the hinge axis (i.e., the cumulative width of knuckles 8 and 9) the larger can be the skew angle. However, the shortness of the hinge axis is limited by structural demands in view that the hinge is the main door support member. If the hinge axis is too short, the hinge can fail or cause the door to wobble during movement. Thus in any, given deployment of the novel hinge system, it is desirable to have the peal( of the knuckles come close to the fender such that the door opens to maximum height and wing span. A high opening door beneficially provides a wider, more convenient and comfortable step-in entrance for the automobile occupant and gives the automobile a desirably more flamboyantt and extraordinary visual appearance with the doors open. To allow the door to rise high, the depth of channel 14 should be increased as much as possible so that the arm does not contact the fender.

From FIG. 2, it is seen that with the door closed, the novel hinge and associated parts fit within the space 30 forward of the forward-facing wall 24 of tile door and between the outward facing wall 26 of the chassis and the fender 20. Also, the forward edge 29 of the outside surface of the door 28 meets closely with the trailing edge 21 of the fender 20, thus providing OEM quality fit and finish. This figure also shows that the maximum depth D of channel 14 is constrained by the chassis wall 25. If the channel is made deeper it could allow the door to open wider however a deeper channel would interfere with the chassis thus preventing the door from closing tightly.

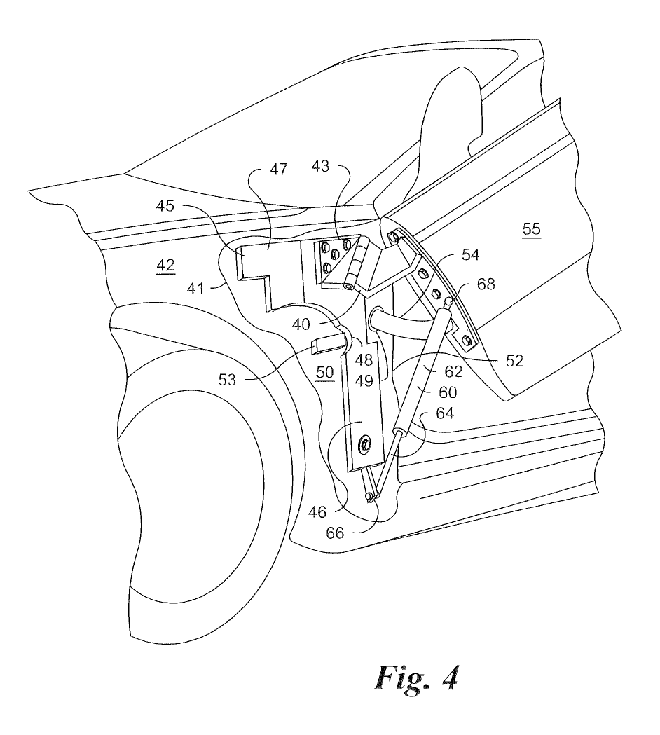

Aspects of the novel hinge system can be further explained with reference to FIG. 4. The figure shows a hinge component 40 substantially as described in relation to FIG. 1 under a cut away area 41 of an automobile fender 42. FIG. 4 further illustrates a preferred embodiment in which the chassis mounting plate incorporates the adjustment function of a mounting alignment component. Accordingly, the system is simplified by obviating the need to have a separate mounting alignment component sandwiched between the chassis mounting plate and the chassis base of the hinge. Thus it is seen that the chassis base 43 is attached to the chassis mounting plate 45 which is affixed to the outward facing wall 50 of the chassis.

The profile of the chassis mounting plate is not critical. The figure illustrates an inverted L-shape profile that should be suitable for many automobile body styles. Chassis mounting plate 45 comprises an elongated strong metal sheet 46 having a long dimensional aligned substantially parallel to the forward door jamb 52. The long dimension extends from above the chassis base of the binge near the top of the chassis to a distance of at least half the height of the door jamb. The illustrated chassis mounting plate includes an options a Forward projection 47. The projection expands the area over which the force transmitted through hinge 40 is distributed to the chassis such that the stress at any point in contact with the chassis mounting plate is further reduced.

The surface contour of the side of the chassis mounting plate 45 complements the contour of the adjacent area of the outward facing wall 50 of the chassis. Thus for example, in an area where the chassis wall exhibits convex curvature, the mounting plate surface in contact with the chassis should have a corresponding concave curvature. The complementary contour feature contributes to providing enhanced stability and strength to the system components for consistently good fit of the door in the jamb and door operation. Plate 4.5 can have cut outs 48 to avoid contacting objects such as represented by element 53 that protrude above the surface of the outward facing chassis wall 50. The plate also may include perforations 49 so as to allow objects to pass through for example wiring harness 541 and other cables or conduits running from the chassis to the door 55.

Characteristics of most of the outward facing surface of the chassis mounting plate are not critical except in the area contacted by the chassis base of the binge. Firstly, in that area the surface contours of the chassis base 43 and the chassis mounting plate 45 should be complementary to provide a stable foundation for attachment of the chassis base. Secondly, that area also includes functional features capable of permitting adjustment of the chassis base position for optimum alignment of the door with the door jamb. These features are the same as those described above in relation to the mounting alignment component. For example, the area can have threaded holes or studs positioned to correspond with holes of the chassis base. As above, all of the chassis base mounting holes except one are oversized to permit rotation of the chassis base until proper alignment is determined. Optionally, the chassis base and chassis mounting plate can be welded to further strengthen the bond between parts after the alignment adjustment is completed.

The function of a lifting strut 60 adapted to provide assistance with the operation of the door 55 is understood with reference to FIG. 4. The assistance provided by the lifting strut is in the form of, for example, but not limited to, structural support, lift assist, closing resistance, door positioning, and door control. In one aspect the lifting strut counter-balances the weight of the door so that after releasing the door latch, the door can be moved upward with little manual force applied by the operator. Without such a lifting strut, the door operator- would need to push the door upward forcefully in order to raise the door for entry to and exit from the vehicle. Similarly, the lifting strut provides static support such that the heavy door remains elevated in the open position when the operator stops lifting and prevents the door from slamming shut.

Typically the lifting strut has the ability to continuously vary its length such that it spans between the door and the chassis at all positions of the door from fully closed to fully opened. Apparatus that can serve the function of the lifting strut include, but are not limited to, a gas spring, a pneumatic piston, a hydraulic piston, a rack and pinion set, electrically-driven lifting strut, a spring-loaded telescoping hinge, and an electromagnetic linear lifting strut.

Preferably the lifting strut is a gas spring. Gas springs are slim and can fit within the available narrow gap between the forward facing wall of the door between fender and chassis wall. Also, gas springs are durable, non-power consuming and light weight. The structure of gas springs is well known in the art. Typically, they take the form of a narrow, elongated cylinder 62 with a concentrically disposed piston rod 64 protruding from one end. The cylinder is loaded with a charge of a gas composition such that the piston can forcefully extend from the cylinder as the gas expands. The piston rod can be retracted into the cylinder thereby re-compressing the gas.

As adapted to the novel hinge system, one lifting strut end 66 connects to a low position affixed to the chassis and the other lifting strut end 68 connects to a high position on the forward facing wall of the door. Preferably, the low position end of the strut can be connected at or near the lower extremity of the chassis mounting plate 45. The high position end of the strut is preferably connected to the door mounting plate of the hinge. Connections of the strut to the chassis and door can be achieved with appropriate brackets. The connections between the automobile parts and the lifting strut ends are adapted to provide multi-dimenisional freedom of pivoting movement. Such connections accommodate displacement as the door is opened and closed and as the piston extends from and retracts into the cylinder. Coupling means that provide the necessary pivoting movement are well known in the art and include, but are not limited to, ball joints and universal joints.

In the aspect of providing lift assistance in operating the novel hinge system to open and close the door, the lifting strut performance characteristics can be selected to resist movement from a stationary position. In operation, such a lifting strut will remain in the piston rod-extended position when the door is positioned in the fully open, uplifted position. This keeps the door from closing immediately under its own weight after the operator stops pushing upward.

Gas springs cant have variable extension dynamics such that the rate at which the piston rod extends from the cylinder depends on the distance of extension. For example, the piston rod may extend faster when it is extended just a short distance and slower when the piston rod is extended nearly fully. Without wishing to be bound by a particular theory, this behavior is thought attributable to the fact that the volume behind the piston increases as the piston rod extends. At a larger volume, the fixed amount of contained gas exerts a lower pressure against the piston which slows the extension.

A gas spring selected for optimum speed and force at low piston rod extensions, i.e., when the door is nearly closed, can provide too slow and/or too little force when the door is nearly fully elevated and open. To boost the rate of extension at higher piston rod extensions, one can select a more powerful gas spring. If the gas spring is too powerful, it can open with too great a force and extension at the door fully open position. When the door opens too wide it can cause damage to the finished parts of the automobile such as the door and fender. It is therefore desirable to utilize an extension limiting component to stop the door from opening beyond the critical point. Extension limiting elements also can assure the aesthetically pleasing effect that all doors open exactly to the same height. Various techniques can be employed to limit the opening of the door. Representative examples include, selecting a lifting strut with a maximum extended length equal to or less than the critical extension, changing positions of the lifting strut connection brackets, and placing an angle of rotation stop on the hinge. The hinge rotation angle limiter technique can be implemented by installing strategically placed bosses on the hinge knuckles 8 and 9 that prevent the tabs 3 and 5 from opening upward too far.

In another aspect in accordance with the present invention, the lifting strut 60 can be selected to provide resistance to movement, for example by friction, to support the door such that the door remains stationary when released in any partially open position throughout its range of motion.

In yet another aspect in accordance with the present invention the lifting strut can be selected to include a power-assist functionality. That is, the lifting strut can be linked to a motor driven mechanism. For example, a motor can drive such lifting struts as an electrically operable rack and pinion, hydraulically driven piston or chain drive that causes the door to open and close when the motor is energized. The motor for the lifting strut can be commanded to open and close the door by actuation of a wired control switch or by a wireless transmitter-receiver control switch system.

Installing the novel hinge system basically utilizes the following typical process. The fender forward of the door (for front vehicle doors) is temporarily removed to expose the outward facing wall of the chassis. Removing the fender provides greater access for tools to the chassis wall and helps prevent damage to the fender during the attaching steps of the process. The existing COEM door hinges are removed separating the door from the vehicle. Wire hanesses and ventilation ducts, if any, are temporarily disconnected or protected if necessary to prevent damage during the subsequent steps. One side of the novel hinge (i.e.,the side with second tabs arm and door base) is affixed to the forward wall of the door. A chassis mounting plate is affixed to the outward facing wall of the chassis. The other side of the novel hinge now connected to the door is affixed to the chassis. Preferably a mounting alignment component is affixed to the chassis wall and the chassis base of the hinge is mounted onto it. Optionally, a chassis mounting plate is affixed to the chassis wall arid the hinge with mounting alignment component is affixed to the plate. Still another alternative option is to use a chassis mounting plate with an integral mounting alignment component. With the door closed, fasteners on the alignment component are tightened sufficiently to hold the door in place yet allowing slight play around a pivot position of the alignment component. When the door is properly aligned in the door jamb, the alignment component fastners are tightened. The lifting strut is attached between a lower portion of the chassis mounting plate and the forward facing wall of the door, preferably to a bracket on the door base or door mounting plate. Wire harnesses and ventilation ducts can be reconnected and the fender reattached to the body of the vehicle.

Different embodiments of the novel hinge system can include various combinations of the above-mentioned components to better suit the needs of different consumers and applications. One contemplated embodiment is a universal hinge kit consisting essentially of a hinge and a mounting alignment component. The consumer can either fashion customized mounting plates from sheets of stock metal or obtain roughly shaped, flat sheet mounting plates offered as accessories to the basic hinge and alignment component set. The consumer might need to refine the shape of the universal accessory mounting plates to fit a particular vehicle application. The universal kit would call on the consumer to independently obtain a lifting strut from available products guided by recommendations of the hinge system provider or available as an additional accessory offered by the hinge system provider. Also some customization is called for to mount the lifting strut.

A universal hinge containing just a hinge and mounting alignment component is directed primarily for installation by a skilled artisan or professional technician because for each individual vehicle some customizing of the plates and struts to fit the hinge to the vehicle is likely. However, since these parts are easily added to the vehicle without having to modify the vehicle structure, customization is not expected to be difficult for an automotive body shaping technician of ordinary skill and without undue experimentation. The custom shaping, if any, of the plates to fit the vehicle and mount the strut should be minor in many circumstances and therefore even a retail consumer with access to appropriate metal working tools should be capable of installing the universal hinge kit. This universal hinge and mounting alignment component kit would also benefit a professional installation shop by enabling the shop operator to stock many of these identical kits all of which would need only a few parts to modify to fit particular vehicles, namely, strut, door plate and chassis plate.

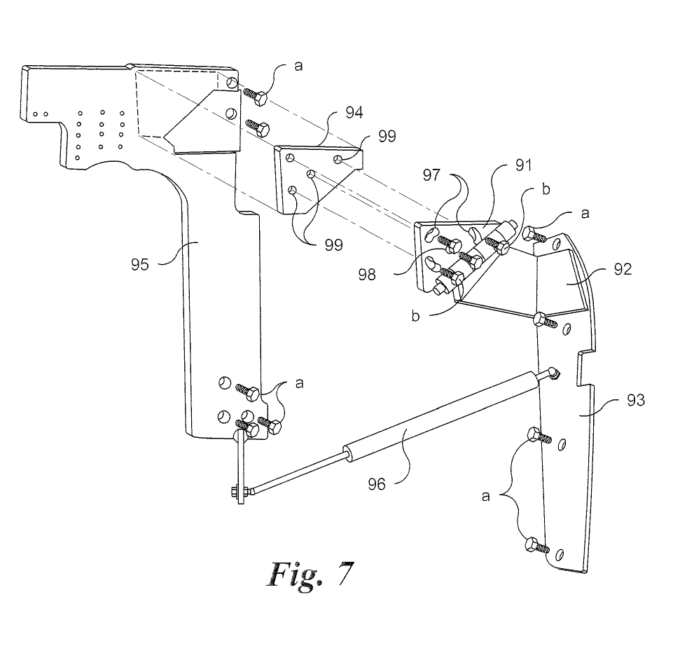

In another contemplated embodiment, the novel hinge system can be presented as a kit for vehicle specific applications. FIG. 7 shows an exploded perspective view of the parts of such a vehicle specific hinge system kit 90. This kit includes a hinge 91, a door mounting plate 93, (shown as optionally pre-attached to the door base 92), a mounting alignment component 94, a chassis mounting plate 95, a lifting stunt 96, and assembly hardware such as, mounting plate attachment bolts a and and hinge alignment bolts b. Such kits can include the hinge, the alignment component and chassis mounting plate.

FIG. 7 further illustrates a different embodiment of the mounting alignment component feature. In the illustrated embodiment the mounting alignment component 94 is intended to be affixed to the chassis mounting plate 95 in the position shown, for example by welding. Component 94 has threaded bores 99 adapted to mate with hinge alignment bolts b. After chassis base of the hinge is placed against the mounting alignment component 94, a single hinge alignment bolt b is inserted through mating hole 98 and threaded into corresponding hole 99 of the alignment component. This hinge is supported by the single bolt while the door is aligned in the jamb as mentioned above. Then remaining hinge alignment bolts b are inserted through oversize holes 97 of the chassis base, threaded and tightened to fix the position of the hinge. To accommodate hinge alignment bolts, the chassis mounting plate 95 can be drilled out where the bolts would interfere.

The door base and door mounting plate can optionally be combined into a, single element for a vehicle specific design. In the alternative a vehicle specific door mounting plate can be provided for the consumer to assemble with a corresponding vehicle specific door base. That is, rather than being pre-attached as in FIG. 7, the door mounting plate and door base are fabricated as a single element. In another preferred embodiment, the functions provided by the mounting alignment component are integrated into the chassis mounting plate. Thus a kit including the hinge with door mounting plate and separate chassis mounting plate equipped with mounting alignment features can be provided for a usually perfect fit to a specific model vehicle. Also, the vehicle specific kit should preferably include lifting strut and strut mounting brackets such that the installer can retrofit a specific vehicle without having to make substantial modifications or additions to the supplied parts.

The novel automobile door hinge has been explained primarily in context of the driver's side, front door. It is contemplated that similar principles can be applied to adapt the novel hinge system to the passenger side of the vehicle as well.

Although specific forms of the invention have been selected in the preceding disclosure for illustration in specific teens for the purpose of describing these forms of the invention fully and amply for one of average skill in the pertinent art, it should be understood that various substitutions and modifications which bring about substantially equivalent or superior results and/or performance are deemed to be within the scope and spirit of the following claims.

What is claimed is

1. A hinge system for moving a door of an automobile through an arc about a single axis comprising
at most one binge element comprising (i) two tabs extending substantially radially outward from the axis, the second tab being pivotable about the axis relative to the first tab, (ii) a chassis base affixed to the first tab, (iii) an elongated and affixed at a first end to the second tab, and (iv) a door base affixed to the end of the elongated arm opposite the first end,
in which the axis is oriented at a substantially oblique angle to horizontal and vertical directions, and
in which the second tab, arm and door base defines a U-shaped channel

2. The binge system of claim 1 in which the chassis base is adapted for fixed attachment to an outward facing wall of a chassis of the automobile forward of the door, in which the door base is adapted for fixed attachment to a forward facing wall of the door and in which all of the system fits within the space forward of the forward facing wall and between the outward facing wall and an interior wall of a fender of the automobile opposite the outward facing wall.

3. The binge system of claim 2 in which the space includes voids defined by original equipment manufactured vertical axis door hinges removed from the automobile.

4. The binge system of claim 3 in which at least one of the chassis base and the door base is adapted for fixed attachment to the automobile by bolts inserted into OEM bolt holes for the original equipment manufactured vertical axis door hinges.

5. The hinge system of claim 2 which further comprises a mounting alignment component operative to join the chassis base to the outward facing wall of the chassis such that the door can be adjusted and set to hold a door closed alignment of a substantially original equipment manufactured quality fit and finish clearance with respect to a jamb surrounding the door.

6. The hinge system of claim 5 in which the chassis base has a, planar back side surface and defines a plurality of holes extending through the chassis base normal to the back side surface.

7. The hinge system of claim 6 in which the mounting alignment component comprises a planar face substantially congruent with the back side surface of the chassis base and a plurality of studs protruding outward from the face, each stud positioned to insert within a corresponding hole of the chassis base and adapted to be affixed to the chassis base by a nut fastener, and in which all of the holes except one is oversized relative to its corresponding stud.

8. The hinge system of claim 6 in which the mounting alignment component comprises a planar face substantially congruent with the back side surface of the chassis base and defines a plurality of bores penetrating inward from the face, each bore positioned to meet a, corresponding hole of the chassis base and adapted to affix the chassis base by a bolt fastener, and in which all of the holes except one is oversized relative to its corresponding bolt fastener.

9. The hinge system of claim 5 which further comprises a, chassis mounting plate having an area substantially greater than that of the chassis base and adapted to deploy between the outward facing wall of the chassis forward of the door and the chassis base.

10. The hinge system of claim 9 in which the mounting alignment component is sandwiched between the chassis mounting plate and the chassis base.

11. The hinge system of claim 9 in which the mounting alignment component is an integral part of the chassis mounting plate.

12. The hinge system of claim 2 which further comprises a chassis mounting plate having an area substantially greater than that of the chassis base and adapted to deploy between the outward facing wall of the chassis forward of the door and the chassis base in which the chassis defines OEM bolt holes for two original equipment manufactured vertical axis door hinges, and in which the chassis mounting plate defines mounting holes that correspond in position with the OEM bolt holes for at least one of said vertical axis door hinges such that the chassis mounting plate can be bolted to the chassis using bolts inserted into the OEM bolt holes provided for at least one of said vertical axis door hinges.

13. The binge system of claim 12 in which the mounting holes correspond in position with the OEM bolt holes of both of said vertical axis door hinges such that the chassis mounting plage can be bolted to the chassis using bolts inserted into the OEM bolt holes provided for two of said vertical axis door hinges.

14. The hinge system of claim 2 which further comprises a chassis mounting plate having an area substantially greater than that of the chassis base and adapted to deploy between the outward facing wall of the chassis forward of the door and the chassis base in which the chassis mounting plate has a lower section extending vertically below and distant from the axis of the hinge, and a length-varying lifting strut spanning between the lower section and the door,

15. The hinge system of claim 14 in which the lifting strut is a gas spring.

16. The hinge system of claim 14 which further comprises extension limiting means for stopping the door from opening beyond a preselected point.

17. The hinge system of claim 1 in which the door comprises a forward facing wall which defines bolt holes provided to mount at least one original equipment manufactured vertical axis door hinge, and which further comprises a door mounting plate sandwiched between the forward facing wall of the door and the door base, said door mounting plate defining bolt holes positioned to enable bolting the door mounting plate to the door with said bolt holes provided for at least one of said original equipment manufactured vertical axis door hinges.

18. The hinge system of claims 17 in which the door mounting plate defines bolt holes poistioned to enable bolting the door mounting plate to the door utilizing bolts inserted into the bolt holes provided for two of the original equipment manufactered vertical hinges.

19. The hinge system of claim 1 in which the automobile comprises a windshield that defines a first plane, the door defines a second plane and in which the position and oblique angle of the axis are effective to move the door in an arc between a closed position latched in a doorjamb of the automobile and an open position in which the second plane of the door is substantially coplanar with the first plane of the windshield.

20. A method of retrofitting a door of an automobile to open obliquely comprising the steps of
(A) providing an automobile having a chassis, a fender and an originally manufactured door with a vertical axis hinge that opens the door only in a horizontal arc,
(B) removing the vertical axis hinge from the automobile and from the door,
(C) providing a hinge system comprising at most one hinge element comprising (i) two tabs extending substantially radially outward from the axis, the second tab being pivotable about the axis relative to the first tab, (ii) a chassis base affixed to the first tab, (iii) an elongated and affixed at a first end to the second tab, and (iv) a door base affixed to the end of the elongated arm opposite the first end, in which the axis is oriented at a substantially oblique angle to horizontal and vertical directions, and in which the second tab, arm and door base define a U-shaped channel,
(D) affixing the door base to a forward facing wall of the door,
(E) positioning the hinge system between an outward facing wall of the chassis and an interior wall of the fender opposite said outward facing wall, and
(F) affixing the chassis base to the outward facing wall.
